(19) United States
(12) Patent Application Publication
(10) Pub. No.: US 2017/0085130 A1
(43) Pub. Date: Mar. 23, 2017

(54) MULTIFILAMENT TRANSMITTER COUPLER WITH CURRENT SHARING

(71) Applicant: QUALCOMM Incorporated, San Diego, CA (US)

(72) Inventors: William Henry Von Novak, III, San Diego, CA (US); Linda Stacey Irish, San Diego, CA (US); Cody Wheeland, San Diego, CA (US); Seong Heon Jeong, San Diego, CA (US)

(21) Appl. No.: 14/862,566

(22) Filed: Sep. 23, 2015

(51) Int. Cl. H02J 50/12; H02J 7/02; H02J 50/05

(52) U.S. Cl. CPC H02J 50/12; H02J 50/05; H02J 7/025

(57) ABSTRACT

A wireless power transmitter that provides wireless power via a magnetic field includes electrical connections for a driving signal and a plurality of coupler loops that divide the current generated by the driving signal. The transmitter can be tuned to provide a distributed magnetic field that is more evenly distributed over the transmitter pad. The currents through different coupler loops can be controlled by the relative impedances of the coupler loops. The coupler loops can take on various shapes, such as substantially concentric circular paths and they may overlap. Impedances can be designed using one or more capacitances. Capacitance between coupler loops can be provided. Feed capacitors might be provided at the electrical connections.

### TECHNICAL FIELD

The described technology generally relates to wireless power transmission. More specifically, the disclosure is directed to devices, systems, and methods related to a wireless power transmitter and transmitter coupler.

### BACKGROUND

In wireless power applications, wireless power transfer systems may provide the ability to charge and/or power electronic devices without physical, electrical connections, thus reducing the number of components required for operation of those electronic devices and simplifying the use of those electronic devices. Such wireless power transfer systems may comprise a transmitter coupler and other transmitting circuitry configured to generate a magnetic field that may induce a current in a receiver coupler that may be connected to the electronic device to be charged or powered wirelessly. The transmitter coupler is preferably able to provide a suitable magnetic field. In some configurations, the transmitter coupler can be inefficient, thus wasting energy, and might provide an uneven magnetic field, thus complicating a process of placing a wireless power receiver relative to the transmitter coupler. Consequently, there is an ongoing need to improve the efficiency of performing wireless power transfer.

### SUMMARY

The implementations disclosed herein each have several innovative aspects, no single one of which is solely responsible for the desirable attributes of the invention. Without limiting the scope of the invention, as expressed by the claims that follow, the more prominent features will be briefly disclosed here. After considering this description, one will understand how the features of the various implementations provide several advantages over current wireless transfer systems.

A wireless power transmitter coupler for a transmitter pad that provides wireless power via a magnetic field includes electrical inputs for a driving signal and a plurality of coupler loops that divide the current generated by the driving signal. The transmitter coupler can be tuned to provide a distributed magnetic field that is more evenly distributed over the transmitter pad. The currents through different coupler loops can be controlled by the relative loop impedances of the coupler loops. The coupler loops can take on various shapes, such as substantially concentric circular paths and they may overlap. Impedances can be designed using one or more capacitances. Capacitance between coupler loops can be provided. Feed capacitors might be provided at the electrical inputs.

Apportionment of current from the driving signal to the first current and to the second current can be determined by a proportion of a first loop impedance of the first coupler loop and a second loop impedance of the second coupler loop, wherein the first loop impedance and the second loop impedance divide the current from the driving signal to create a distributed magnetic field that is more evenly distributed over the transmitter pad than if the first current and the second current are constrained to be equal. This apportionment can be extended beyond two coupler loops.

The loop impedances of the coupler loops might be inversely proportional to their size, so that more current is carried by larger coupler loops, with loop impedance being determined at a driving signal frequency that could be between 1 MHz and 10 MHz and might be around 6.78 MHz.

Some coupler loop paths might be circular, while others have paths approximating a rectangle for a majority of their paths. Some coupler paths might include added inductors.

One aspect of the disclosure provides a wireless power transmitter for generating a magnetic field. The wireless power transmitter includes a first coupler loop that is coupled between a first electrical connection and a second electrical connection. The first electrical connection and the second electrical connection capable of receiving a driving signal and configured to allow the driving signal applied across the first electrical connection and the second electrical connection to cause a first current to flow in the first coupler loop and generate a first magnetic field component. The wireless power transmitter further includes a second coupler loop that is coupled between the first electrical connection and the second electrical connection. The first electrical connection and the second electrical connection further configured to allow the driving signal applied across the first electrical connection and the second electrical connection to cause a second current to flow in the second coupler loop and generate a second magnetic field component. The first current is different from the second current.

A wireless power transmitter may include circuitry configured to generate a driving signal, a pair of electrical connections including a first electrical connection and a second electrical connection, a transmitter pad coupled to the pair of electrical connections to receive the driving signal, a first coupler loop, a second coupler loop, and tuning elements that tune a resonance of the first coupler loop and the second coupler loop independently of each other. The first coupler loop is along a first path enclosed within the transmitter pad, coupled between the first electrical connection and the second electrical connection. The second coupler loop is along a second path enclosed within the transmitter pad, coupled between the first electrical connection and the second electrical connection, the second coupler loop being electrically in parallel with the first coupler loop and separated from the first coupler loop along a loop longitude sufficient to generate distinguishable magnetic field components among the first coupler loop and the second coupler loop.

A method of providing power wirelessly to devices having wireless power receivers and positioned to wirelessly receive power via a magnetic field might include receiving a driving signal across a pair of electrical connections comprising a first electrical connection and a second electrical connection, apportioning current of the driving signal to a first coupler loop and a second coupler loop, the first coupler loop being along a first path connecting the first electrical connection and the second electrical connection and the second coupler loop being along a second path connecting the first electrical connection and the second electrical connection, generating a first magnetic field component when a first current flows in the first coupler loop, and generating a second magnetic field component when a second current flows in the second coupler loop, wherein the second path is sufficiently distinct from the first path that the first magnetic field component and the second magnetic field component are distinguishable to a wireless power receiver, wherein the first current is different than the second current.

A wireless power transmitter may include means for generating a driving signal, means for conveying a driving signal current, first means for emitting a first magnetic field, second means for emitting a second magnetic field, means for supporting the first means for emitting along a first path and the second means for emitting along a second path separated from the first path sufficient to generate distinguishable magnetic field components as between the first means for emitting and the second means for emitting, means for partitioning the driving signal current between the first means for emitting and the second means for emitting, and means for tuning a resonance of the first means for emitting and the second means for emitting independently of each other.

The following detailed description together with the accompanying drawings will provide a better understanding of the nature and advantages of the present invention.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be drawn to scale.

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is an illustration of a transmitter pad upon which various devices might be placed in a process of wireless power transfer.

FIG. 4 is a block diagram that illustrates interconnections of a wireless power transmitter amplifier and a transmitter coupler.

FIG. 5 illustrates a transmitter coupler arranged to create a magnetic field for wireless power transfer.

FIG. 6 is a diagram of a multifilament transmitter coupler with current sharing, having a first loop and a second loop, in accordance with an exemplary implementation.

FIG. 7 is a diagram of a multifilament transmitter coupler with current sharing, having four loops, in accordance with another exemplary implementation.

FIG. 8 is a diagram of a multifilament transmitter coupler with current sharing, having eight loops, in accordance with another exemplary implementation.

FIG. 9 is a plot of magnetic field intensity of a field that might be generated using the coil arrangement of FIG. 8.

FIG. 10 is a diagram of a simulated multifilament transmitter coupler with current sharing, having five circular loops, in accordance with another exemplary implementation.

FIG. 11 is a plot of magnetic field intensity of a field that might be generated using a coil arrangement in a simulation of the simulated multifilament transmitter coupler of FIG. 10.

FIG. 12 is a schematic diagram of a circuit designed to implement the multifilament transmitter coupler represented in FIGS. 10-11.

FIG. 13 is a table of exemplary circuit element values of the circuit components illustrated in FIG. 12.

FIG. 14 is a diagram of a multifilament transmitter coupler with current sharing, in accordance with a further exemplary implementation.

FIG. 15 is a diagram of a multifilament transmitter coupler with current sharing, having two loops with matched lengths, in accordance with a further exemplary implementation.

FIG. 16 is a diagram of a multifilament transmitter coupler with current sharing, having loop-to-loop coupling capacitors, in accordance with a further exemplary implementation.

FIG. 17 is a diagram of a multifilament transmitter coupler with current sharing, having multiple loops each having capacitors and inductors, in accordance with a further exemplary implementation.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

In a specific example, a wireless power transfer system involves transmitters and receivers, wherein a transmitter has a power source, circuitry and/or logic for generating a driving signal that drives a wireless power transmitter coupler. In response to the driving signal, the transmitter coupler generates a magnetic field having certain characteristics. A wireless power receiver includes a receiver coupler that extracts energy from that magnetic field, converts it to usable electrical energy and provides it to the receiver of, for example, an electronic device, circuitry and/or logic for use in various applications. The transmitter coupler may be designed in a way that allows power to be conveyed to the receiver without requiring that the receiver be placed or positioned in an exact position or orientation.

More generally, wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a receiver coupler, such as an antenna or other element, to achieve power transfer from the transmitter to the receiver.

In an exemplary wireless power transfer system, a power source provides input power to a transmitter that generates a driving signal that drives a transmitter coupler to generate a wireless (e.g., magnetic or electromagnetic) field. A receiver has a receiver coupler that absorbs some of the energy of the wireless field when the receiver coupler is present in the wireless field. The receiver uses that energy to power circuitry electrically connected to the receiver and/or to store that energy for later use, such as in a battery. The absorbed energy might be used by a device having an integrated receiver or the device might be connected, via a charging connector on the device for example, to a separate receiver unit. Being wireless power transfer, the transmitter and the receiver are separated by a distance, which might be small or large relative to the transmitter and receiver.

The transmitter includes a transmitter coupler that generates the wireless field. The coupler might be shaped to allow for various placements of one or more receiver couplers relative to the transmitter coupler. The transmitter coupler might be embedded in a transmitter pad constructed of nonconductive material suitable for supporting the receiver and/or the device being charged. The transmitter coupler can be an antenna or coil, and can be designed for resonant or non-resonant use, where resonant use refers to the case where the transmitter coupler forms a portion of a resonant circuit (e.g., an LC circuit) and is driven with a driving signal that has a primary alternating current (AC) time-varying component with a frequency at or near the resonant frequency of the resonant circuit. The transmitter might include circuitry and or logic that alters the driving signal based on feedback about the nature, quantity, etc., of wireless power receivers that are absorbing energy from the wireless field generated by the transmitter coupler.

In some implementations, the wireless field may correspond to the “near-field” of the transmitter coupler. The near-field may correspond to a region in which there are strong reactive fields resulting from the currents and charges in the transmitter coupler that minimally radiate power away from the transmitter coupler. The near-field may correspond to a region that is within about one wavelength (or a fraction thereof) of electromagnetic signals at the designed frequency. The near-field is an area around a coupler that in which electromagnetic fields exist but do not propagate or radiate away from the antenna. They are typically confined to a volume that is near the physical volume of the antenna. In the exemplary embodiments of the invention, magnetic-type antennas, such as single-turn and multi-turn loop antennas might be used in a transmitter coupler and a receiver coupler, since magnetic near-field amplitudes tend to be higher for magnetic-type antennas in comparison to the electric near-fields of an electric-type antenna (e.g., a small dipole).

Regardless of whether near-field or other fields are used, the transmitter coupler is often designed and configured with certain design parameters in mind. For example, a transmitter coupler might be designed and implemented in a way that allows it to transmit power to a receiver device within the charging region of a few feet at a power level sufficient to charge or power the receiver device but is not designed or implemented to transmit significant power across hundreds of feet. Notwithstanding, it should be understood that in generating a wireless field, there are typically not strict boundaries for the wireless field and the wireless field might continue on indefinitely with slowly decreasing intensity. Therefore, while a wireless power transmission system might be described as having a charging field or region, the boundaries need not be precisely defined.

The transmitter coupler and the receiver coupler may further be configured according to a mutual resonant relationship. When the resonant frequency of the receiver coupler and the resonant frequency of the transmitter coupler substantially the same or very close, transmission losses between the transmitter coupler and the receiver coupler are reduced. Resonant inductive coupling techniques may allow for improved efficiency and power transfer over various distances and with a variety of inductive coil configurations. In this manner, the transmitter coupler might output a time-varying magnetic field with a frequency corresponding to the resonant frequency of the transmitter coupler and the receiver coupler, when it is within the wireless field, experiences an induced current from that time-varying magnetic field. The alternating current induced in the receiver coupler may be rectified as described above to produce direct current (DC) energy that may be provided to charge a battery or to power a load. In addition to conveying power wirelessly, the transmitter and receiver might also communicate data using the wireless field and/or communicate on a separate communication channel (e.g., Bluetooth, ZigBee, cellular, etc.).

As mentioned above, the transmitter might comprise a power source and a transmitter coupler. The transmitter might also include various circuitry and logic elements, such as an oscillator, a driver circuit, and various filters, matching circuits and other components. The oscillator may be configured to generate a signal at the desired frequency and that desired frequency might be adjustable in response to a frequency control signal. The driver circuit would have the oscillator signal as its input, then drive input terminals of the transmitter coupler. The electrical connection terminals can be detachable terminals or integrated terminals. The driver circuit would drive the transmitter coupler at, for example, a resonant frequency of the transmitter coupler by applying an input voltage signal to the connection terminals. The driver circuit may be a switching amplifier configured to receive a square wave from the oscillator and output a sine wave or square wave. Filters might be used to filters out harmonics or other unwanted frequencies and matching circuits might be used to match the impedance of the transmitter to the transmitter coupler. As a result of driving the transmitter coupler, the transmitter coupler may generate the wireless field at a level sufficient for conveying energy to the receiver coupler.

As used herein, a “coupler” refers to a component that wirelessly outputs energy or wirelessly receives energy, with a “transmitter coupler” referring to a coupler that wirelessly outputs energy and a “receiver coupler” referring to a coupler that wirelessly absorbs or receives energy. However, even with those uses of those terms, it should be understood that a transmitter coupler might absorb some energy while outputting energy or otherwise and a receiver coupler might emit some energy while absorbing some energy or otherwise. A coupler might be in the form of an antenna, such as a loop of wire or metal, having a particular position. The coupler might be an induction coil.

Where the coupler has a particular shape, that shape might be in the form of an elongated wire, metal strip or conductor having another cross section, and might be described in terms of a path. For example, a flat induction coil might have a spiral path wherein much of the flat induction coil follows a substantially circular path except for perhaps the ends of the flat induction coil, which might be substantially linear with one end of the coil connected to an inner portion of the spiral path passing over other portions of the coil to reach outside the spiral path without significant electrical conductivity with the portions of the coil that are being crossed. The coupler might rely on an air core, a physical core such as a ferrite core, or no core.

The coupler may include, in addition to a conductor having its internal impedance, additional impedance components such as capacitors and inductors. The coupler may form a portion of a resonant circuit configured to resonate at a resonant frequency based on its inductance and its capacitance. For larger diameter antennas, the size of capacitance needed to sustain resonance may decrease as the diameter or inductance of the loop increases. Other resonant circuits formed using other components are also possible.

In examples herein, the transmitter coupler is referred to as being enclosed in, or associated with a transmitter pad, which might be a flat pad that rests on a unit of furniture suitable for placement of receivers, receiver couplers, and/or devices with receiver couplers thereon. The transmitter pad might be integrated into a table, a mat, a lamp, or other stationary configuration.

Specific examples will now be described with reference to the figures.

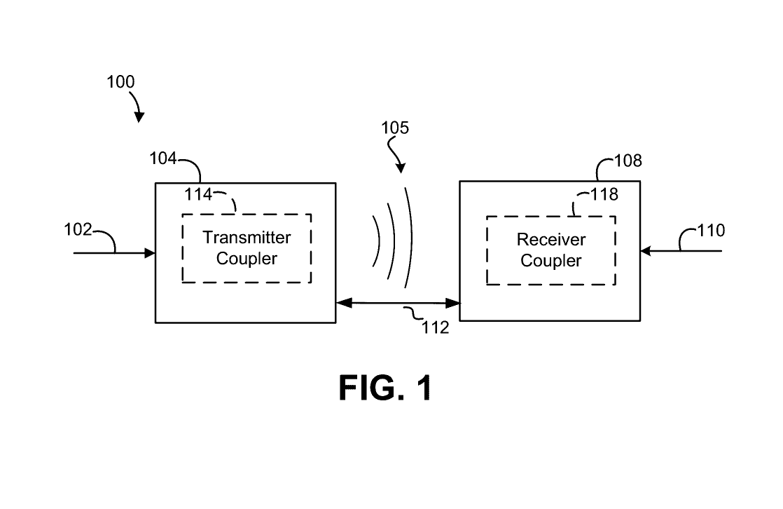

FIG. 1 is a functional block diagram of a wireless power transfer system 100, in accordance with one exemplary implementation. Input power 102 is provided to a transmitter 104 from a power source (not shown in this figure) to generate a wireless (e.g., magnetic or electromagnetic) field 105 for performing energy transfer. A receiver 108 couples to the wireless field 105 and generates output power 110 for storing or consumption by a device (not shown in this figure) coupled to the output power 110. The transmitter 104 and the receiver 108 are separated by a distance 112.

The receiver 108 may wirelessly receive power when the receiver 108 is located in the wireless field 105 generated by the transmitter 104. The transmitter 104 includes a transmitter coupler 114 for transmitting energy to the receiver 108 via the wireless field 105. The receiver 108 includes a receiver coupler 118 for receiving or capturing energy transmitted from the transmitter 104 via the wireless field 105. The wireless field 105 corresponds to a region where energy output by the transmitter 104 may be captured by the receiver 108 and need not be explicitly defined or contained.

In one exemplary implementation, the wireless field 105 may be a magnetic field and the transmitter 104 and the receiver 108 are configured to inductively transfer power. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are reduced. Resonant inductive coupling techniques may allow for improved efficiency and power transfer over various distances and with a variety of inductive coil configurations. When configured according to a mutual resonant relationship, in an implementation, the transmitter 104 outputs a time varying magnetic field with a frequency corresponding to the resonant frequency of transmitter coupler 114.

The wireless field 105 might be nonuniform such that placement and configuration of receiver 108 within the wireless field 105 can determine how efficiently energy is transferred. In some implementations, the frequency is 6.78 MHz, but other frequencies might be used instead, such as 1 MHz to 10 MHz, based on considerations of circuits available to generate the frequencies used, frequencies expected, frequencies that are less likely to interfere with the operation of other electronics, or similar reasons. The 6.78 MHz frequency is useful as that frequency in many jurisdictions is available for uses such as wireless power transfer. The driving signal might not be a single frequency, but might be more varied signal with a primary component at a frequency at which the transmitter coupler and receiver couplers are tuned.

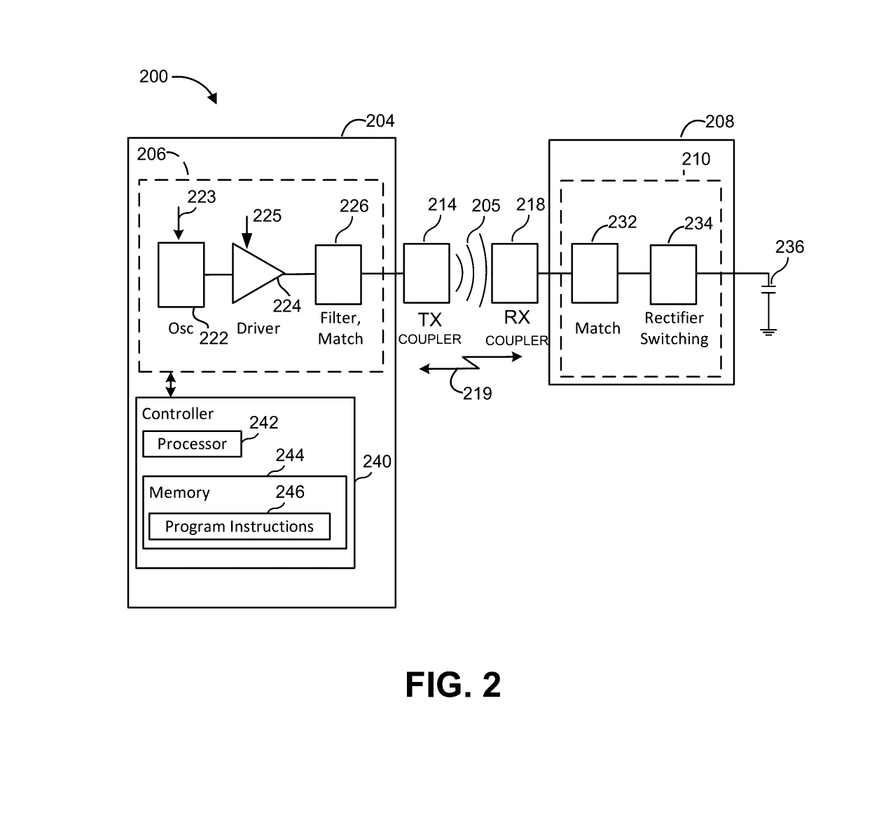

FIG. 2 is a functional block diagram of a wireless power transfer system 200, in accordance with another exemplary implementation. Wireless power transfer system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that is adjusted in response to a frequency control signal 223. The oscillator 222 provides the oscillator signal to the driver circuit 224. The driver circuit 224 is configured to drive a transmitter coupler 214 at, for example, a resonant frequency of the transmitter coupler 214 based on an input voltage signal (VD) 225. The driver circuit 224 may be a switching amplifier configured to receive a square wave from the oscillator 222 and output a sine wave or square wave.

The filter and matching circuit 226 filters out harmonics or other unwanted frequencies and matches the impedance of transmitter 204 to the impedance of transmitter coupler 214. As a result of driving transmitter coupler 214, transmitter coupler 214 may generate a wireless field 205 to wirelessly output power across a distance 219 at a level sufficient for charging a battery such as load 236, for example.

Transmitter 204 might include transmit circuitry, such as a controller 240 that may be implemented using a processor 242 that is coupled with a computer-readable memory 244 that includes program instructions 246 executable by processor 242. In other variations, the controller might comprise a micro-controller, an application-specific integrated circuit (ASIC), or the like. One set of operations of the controller might be to receive information from each of the components of the transmit circuitry, perform calculations based on the received information, and output control signals for each of the components that may adjust the operation of that component. Computer-readable memory 244 might comprise random-access memory (RAM), electrically erasable programmable read only memory (EEPROM), flash memory, or non-volatile RAM, for temporarily or permanently storing data for use in read and write operations performed by the controller and for storing data generated as a result of the calculations of the controller. Other functions are possible, but generally, transmitter 204 is able to generate a driving signal.

The controller might allow for adjusting transmit circuitry 206 and/or its operation, based on changes in the data over time. For example, the controller might provide instructions or signals to oscillator 222 to cause it to generate an oscillating signal at the operating frequency of the wireless power transfer. In some implementations, transmit circuitry 206 is configured to operate at the 6.78 MHz ISM frequency band. The controller may be configured to selectively enable oscillator 222 during a transmit phase (or duty cycle) and may be further configured to adjust the frequency or a phase of oscillator 22 which may reduce out-of-band emissions, especially when transitioning from one frequency to another. As described above, transmit circuitry 206 may be configured to provide an amount of charging power to transmitter coupler 214 via the signal, which may generate energy (e.g., magnetic flux) about transmitter coupler 214.

Transmit circuitry 206 may further include a low pass filter (LPF) operably connected to transmitter coupler 214, configured as the filter portion of matching circuit 226. In some exemplary implementations, the low pass filter may be configured to receive and filter an analog signal of current and an analog signal of voltage generated by driver circuit 224. In some implementations, the low pass filter may alter a phase of the analog signals. For example, the low pass filter may cause the same amount of phase change for both the current and the voltage, canceling out the changes. In some implementations, the controller may be configured to compensate for the phase change caused by the low pass filter. The low pass filter may be configured to reduce harmonic emissions to levels that may prevent self-jamming. Other exemplary implementations may include different filter topologies, such as notch filters that attenuate specific frequencies while passing others.

Transmit circuitry 206 may further include a fixed impedance matching circuit operably connected to the low pass filter and transmitter coupler 214. The matching circuit may be configured as the matching portion of filter and matching circuit 226. The matching circuit may be configured to match the impedance of transmit circuitry 206 to transmitter coupler 214. Other exemplary implementations may include an adaptive impedance match that may be varied based on measurable transmit metrics, such as the measured output power to the transmitter antenna or a DC current of driver circuit 224. Transmit circuitry 206 may further comprise discrete devices, discrete circuits, and/or an integrated assembly of components.

Receiver 208 includes receive circuitry 210 that includes a matching circuit 232 and a rectifier circuit 234. The matching circuit 232 may match the impedance of the receive circuitry 210 to the impedance of receive antenna 218. Rectifier circuit 234 may generate a direct current (DC) power output from an alternating current (AC) power input to charge a load 236, which might be a battery. Receiver 208 and transmitter 204 may additionally communicate on a separate communication channel such as Bluetooth, Zigbee, cellular, or similar channel. Receiver 208 and transmitter 204 may alternatively communicate via in-band signaling using characteristics of wireless field 205.

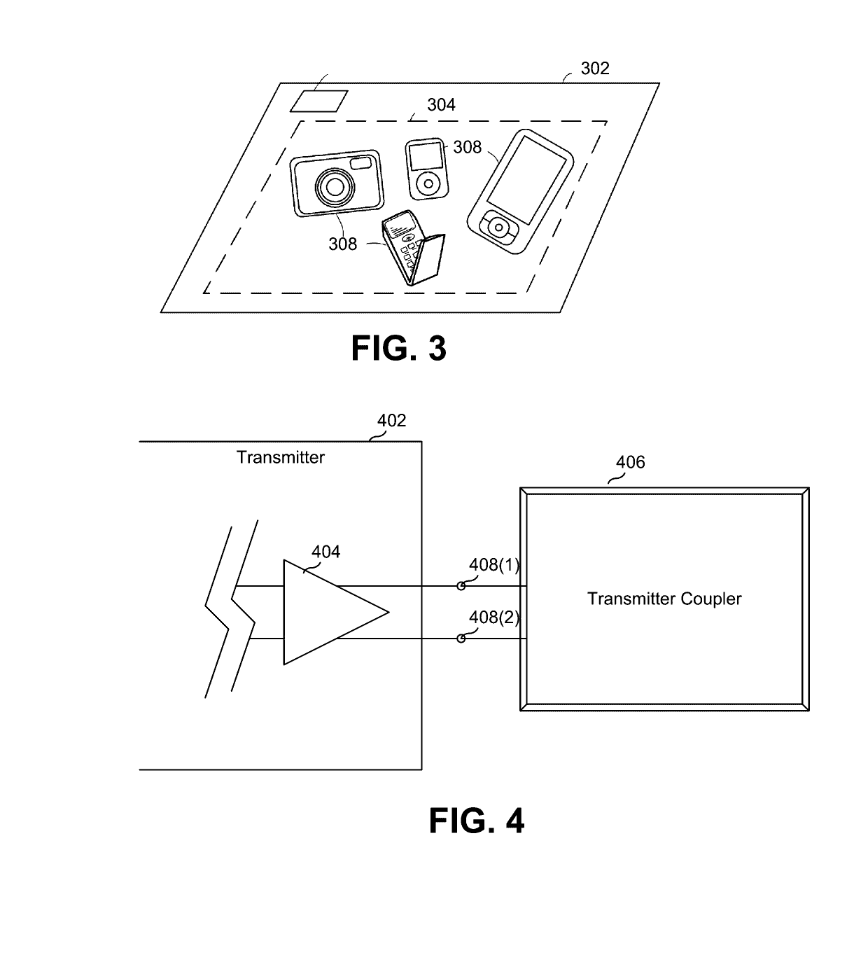

FIG. 3 is an illustration of a transmitter pad 302 upon which various devices might be placed in a process of wireless power transfer. As illustrated, transmitter pad 302 has a large active area 304 onto which devices 308 to be charged can be placed without requiring specific positioning. Transmitter pad 302 might be made of insulating material and devices 308 might include cases or enclosures with some wireless power receiver included as part of the device or as part of a case or enclosure that is in turn electrically connected to a charging input of the device. Transmitter pad 302 may have an approximately rectangular surface of suitable material to hold devices being charged wirelessly with some width dimension and length dimension. The paths of coupler loops that provide the field for the wireless power transfer might be defined so that an approximately even field is provided over some portion of the approximately rectangular surface to accommodate a set of wireless receivers having a predefined range of sizes of receiver couplers simultaneously. In the more general case, wireless power transmitter is designed or configured to have a width dimension and a length dimension wherein the width dimension and the length dimension define an approximately rectangular surface sufficiently large to simultaneously accommodate multiple wireless receivers of the set of wireless receivers, each of which might be placed anywhere on the rectangular surface.

FIG. 4 is a block diagram that illustrates interconnections of a wireless power transmitter amplifier and a transmitter coupler 406. As illustrated there, a transmitter 402 has a driver 404 that is electrically connected to a transmitter coupler 406 via two connections 408(1) and 408(2). Transmitter coupler 406 might be nondestructively detachable from transmitter 402 or might be integrated with transmitter 402 in a way that makes transmitter coupler 406 not readily detachable. In either case, a voltage signal or current signal driven across connections 408(1) and 408(2) would be expected to result in transmitter coupler 406 emitting a field to allow for wireless power output.

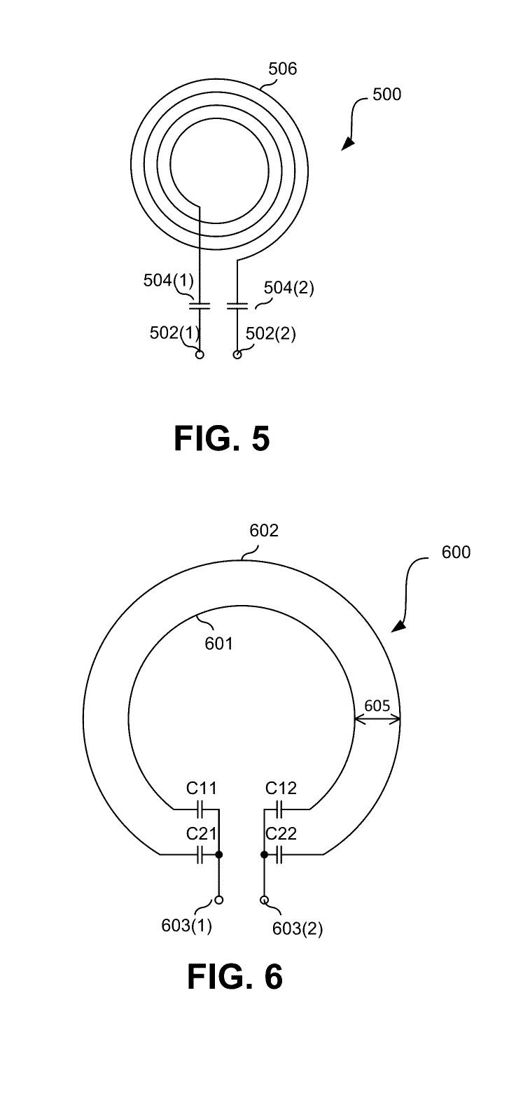

FIG. 5 illustrates a transmitter coupler 500 arranged to create a magnetic field for wireless power transfer. Current input to an connection 502(1) would flow through a capacitor 504(1), a coil 506, a capacitor 504(2) and an connection 502(2). In this example, a concentric resonator is wound such that coil 506 is a coil of moderate inductance. The distributed capacitance presents as shunt capacitance, and causes a self-resonance at some frequency. When this resonance is somewhat close to the operating frequency, it can amplify electromagnetic interference (EMI) present in the driving signal. When configured in a resonant circuit, when coil 506 is at or very close to resonance, it can cause coil 506 to operate as a shunt-tuned coil, severely compromising systems that rely on series tuning. Another problem with the continuous coil resonator is that the same current flows through the entire coil, leading to less evenly distributed magnetic fields.

Additionally, in larger coils, the number of turns must often increase to maintain the same uniformity of field. However, as coil 506 becomes larger, two problems emerge. As coil 506 becomes larger and number of turns increases, the capacitance between each coil turn increases, and eventually coil 506 becomes self-resonant due to the additional capacitance. This self-resonance acts as an unwanted shunt tuning capacitance, causing unwanted behavior and hard-to-control currents. Secondly, as coil 506 becomes larger and number of turns increases, the inductance of coil 506 increases. This is undesirable as the voltage required to drive the coil at a given frequency would go up due to the higher impedance. Also, the electric field (E-field) generated near the terminals of coil 506 goes up as the voltage goes up and the E-field is effectively “wasted energy” as it does not contribute to charging the device, and is generally just a source of inefficiency and EMI. Thirdly, as coil 506 becomes longer, the resistance of the coil might increase.

Often, transmitter designers will avoid the above problems by not adding turns as the transmitter pad size increases. This results in less uniform H-fields, and consequent difficulty in supporting small receivers on the pad.

FIG. 6 illustrates an example of an improved transmitter coupler having a plurality of coupler loops. The magnetic field provided by a coupler loop is a function of the path of the coupler loop and the current that flows through that coupler loop. The magnitude of the field at a particular point in space might be calculated from parameters representing the current through the coupler loop and the shape of the coupler loop's path through a transmitter pad or other element that holds the loop wire in place. For a multifilament transmitter coupler, where different filaments serve as separate coupler loops, the magnetic field provided by the multifilament transmitter coupler is typically a superposition of the fields generated by each coupler loop. Since the magnetic field of one coupler loop is a function of the current that flows through that coupler loop, typically linearly proportional, if one coupler loop generates more magnetic field than another, the ratios of the currents in those coupler loops can be varied so that a coupler loop that generates a weaker field can be provided with more current, and a coupler loop that generates a stronger field can be provided with less current. For example, if one coupler loop has a path concentrated in the center of a transmitter pad and contributes more magnetic field than another coupler loop positioned toward the edges of the transmitter pad, the current provided to the transmitter pad can be split in a way that the outer coupler loop gets more current. The relative impedance of the inner coupler loop can be increased so that relatively more current flows in the outer coupler path.

In a number of examples herein, not intending to be limiting, an apportionment of current from the driving signal to the first coupler loop and the second coupler loop is determined by a proportion of the impedance of the first coupler loop and the impedance of the second coupler loop (e.g., relative impedance). The relative impedances of the first coupler loop and the impedance of the second coupler loop divide the current from the driving signal to create a distributed magnetic field that is more evenly distributed over the transmitter pad than if the first current and the second current are constrained to be equal. This can be extended to more than two coupler loops.

Since the currents in each of the coupler loops do not have to be identical, changes to the configuration of the coupler loops (e.g., changing loop capacitance, loop path length and position, etc.) can be used to more evenly distribute out the field produced by the collection of coupler loops. One way described herein is to alter the impedance of one or more loops, but other ways might be used as well. The relative impedance of the coupler loops can be designed or altered by how the coupler loops are laid out and what capacitance is added to each coupler loop. Where the paths of the coupler loops is fixed, as is often the case with transmitter pads having embedded coupler coils, the intrinsic impedance of the coupler coil and the shape of the magnetic field generated would be relatively fixed, so that tuning the loops by adding capacitance or inductance could be done at the time of manufacture or infrequently.

If tuning need only be done once, it might be done by adding capacitance in a fixed manner. A number of examples of arrangement of coupler loops in a multifilament transmitter coupler are described herein with illustrations and example component values.

FIG. 6 is a diagram of a multifilament transmitter coupler 600 with current sharing, having a first coupler loop 601 and a second coupler loop 602, in accordance with an exemplary implementation. As illustrated there, since the first coupler loop 601 and the second coupler loop 602 are electrically connected electrically in parallel, current can flow separately in each coupler loop. Also shown are connections 603(1) and 603(2), which may be connected to a driver circuit (not shown) that provides the driving signal. In some aspects, the connections 603(1) and 603(2) are configured to allow the driving signal applied across the connections 603(1) and 603(2) to cause a first current through the first coupler loop 601 and a second current through the second coupler loop 602. Current through the first coupler loop 601 can be controlled separately from the current through the second coupler loop 602, by controlling length, capacitance, etc. of the first coupler loop 601, or by providing or varying capacitance of capacitors C11 and C12, relative to capacitance of capacitors C21 and C22. In another embodiment, the capacitance provided by two capacitors in series in a coupler loop is instead provided by a single capacitor in series with the coupler loop path. In some aspects, the first current may be different (e.g., a lower value) than the second current to provide a more evenly distributed magnetic field than would be generated if the same current had run through the first coupler loop 601 and the second coupler loop 602.

Throughout this disclosure, capacitances are identified. It should be understood that such capacitances can be implemented using a capacitor and/or an element other than a capacitor that intentionally and/or parasitically provides the needed capacitance.

The paths of the first coupler loop 601 and the second coupler loop 602 are shown to be substantially circular along a majority of their respective paths, but other variations are possible. In some embodiments, the paths follow rounded rectangles. The paths of the coupler loops are separated by a distance 605, which might be selected to provide for an even field. Typically, the paths are determined by design and are fixed. For example, the paths of the coupler loops might be fixed once the conductors of those loops are embedded into the transmitter coupler pad or other device used to hold the conductors. The relative values of the first capacitor of a loop and the second capacitor might correspond to capacitances that tune the first coupler loop 601 and the second coupler loop 602 so that, at or around a driving signal frequency, the first current and the second current provide a more evenly distributed magnetic field between the first magnetic field component and the second magnetic field component than would be generated if the first current and the second current were equal. In other variations where there are more than two coupler loops, the relative proportions of the impedances of the various loops result in the driving current being apportioned to provide a more evenly distributed magnetic field than would be generated if the driving current had to run through all of the loops in series.

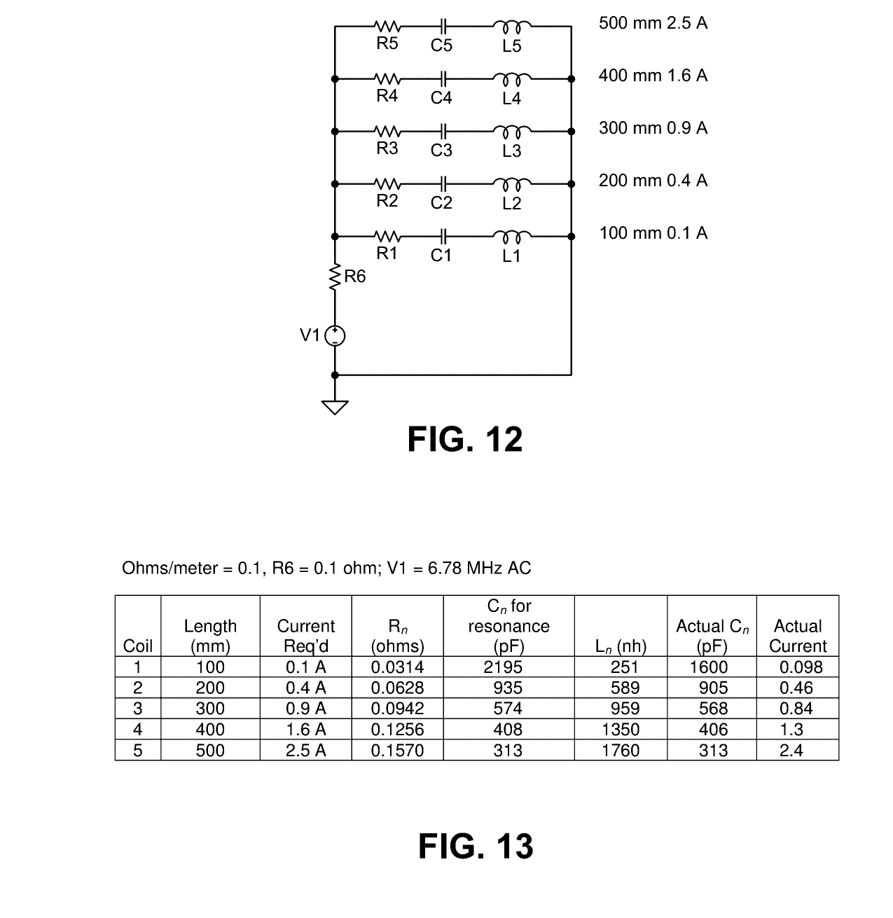

The distances in the figures are not necessarily to scale. In some variations, the loops might be equally spaced throughout by the distance 605, but in other variations, the spacing might vary. The lengths and relative lengths of the loops might vary as well. It should be noted that while FIG. 6 shows two coupler loops, a different number of coupler loops can be deployed, as illustrated in other figures and described herein. The values for capacitances C11, C12, C21, and C22 might be determined using values shown in FIG. 13, which is explained in detail below. While FIG. 13 shows five sets of values that might be used in the circuit of FIG. 12, the values for two consecutive rows of the table in FIG. 13 might be used in the circuit of FIG. 6.

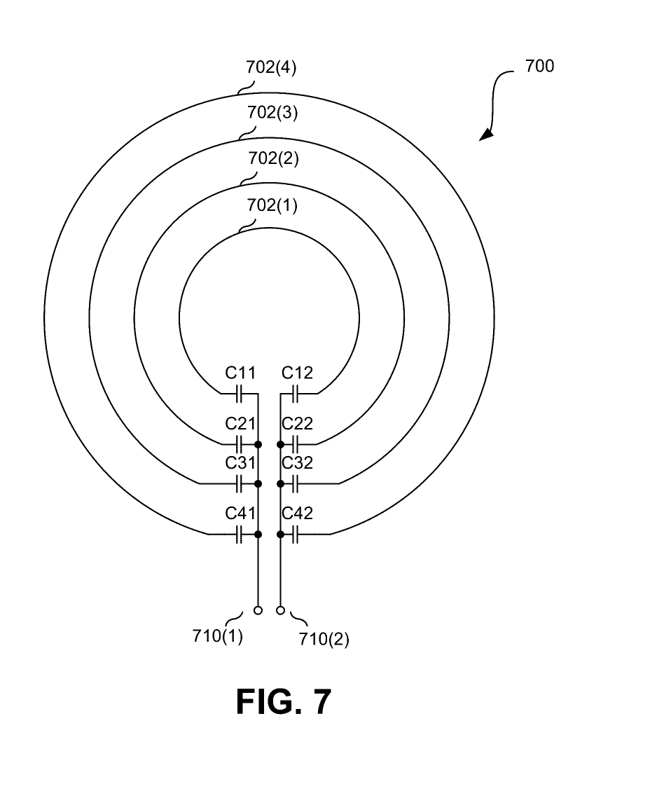

FIG. 7 is a diagram of a multifilament transmitter coupler 700 with current sharing, having four loops 702(1) to 702(4) (collectively referred to as “702”), in accordance with another exemplary implementation. Those loops 702 have corresponding capacitances C11, C12, C21, C22, C31, C32, C41, and C42, as shown. The current induced by the driving signal across connections 710(1) and 710(2) would divide over those four loops based on their impedance at the driving signal frequency. The relative currents could be adjusted by altering the relative lengths of the loops, adding additional capacitance, or other methods, to easily result in relative currents that vary so as to create a uniform H field using a single driver.

The individual loops in parallel can include tuning elements that can be tuned individually or connected together and tuned externally. This largely avoids the problems of self-resonance and allows the possibility of tuning of current in each loop, and also allows designers to use more turns to achieve a more uniform field. The paths of the individual loops might vary depending on the desired shape of the coupling field. With this approach, a wireless power transmitter might have a power source, circuitry for generating a driving signal, a pair of electrical connections for driving a multifilament transmitter coupler that is part of a transmitter pad coupled to the pair of electrical connections to receive the driving signal at a pair of electrical connections. A first coupler loop enclosed within the transmitter pad and a second coupler loop enclosed within the transmitter pad could be separately tuned. The first and second coupler loop can also be spaced apart along defined paths, in parallel or not parallel, with the first coupler loop and separated from the first coupler loop along a loop longitude sufficient to generate distinguishable magnetic field components among the first coupler loop and the second coupler loop.

These tuning elements might be used once during manufacturing or during setup, but might also be usable for varying the tuning from time to time. Tuning elements may tune a resonance of the first coupler loop and the second coupler loop independently of each other. The tuning elements might be elements that have a variable reactance or impedance. In some embodiments, variability of the reactance or impedance can come from switchable elements that are switched into and out of current paths.

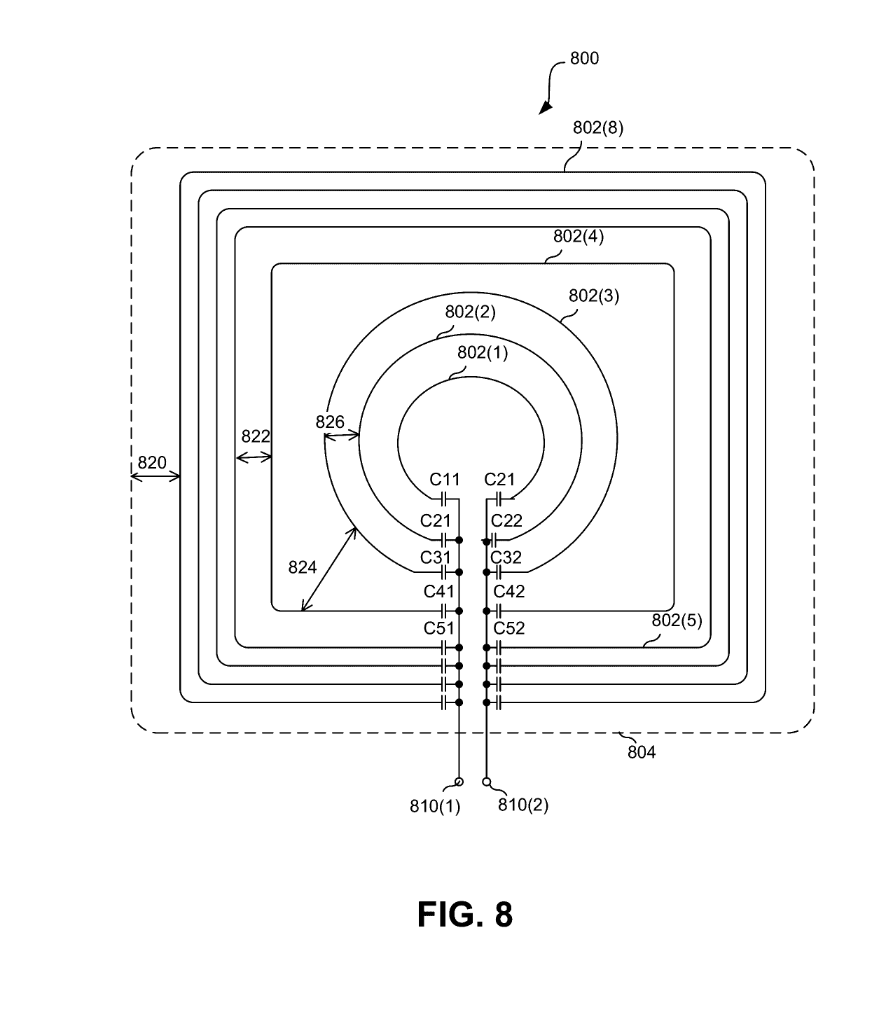

FIG. 8 is a diagram of a multifilament transmitter coupler 800 with current sharing, having eight loops 802(1) to 802(8) (collectively referred to as “802”), in accordance with another exemplary implementation. As illustrated there, loops 802(1) through 802(3) are circular over most of their paths, while loops 802(4) through 802(8) are rectangular over most of their paths. Loops 802 might be embedded within a nonconducting surface 804, which might be part of a pad or a piece of furniture. By appropriate selection of the resonant capacitances C11 through C52, individual loop currents can be handled for multiple loops using one input driver connection (connections 810(1) and 810(2)). In multifilament transmitter coupler 800, a distance 820 between the outermost loop 802(8) and a border of nonconducting surface 804 might dictate the current and field strength needed from loop 802(8). Other distances, such as distance 822 between loop 802(4) and loop 802(5), distance 824 between loop 802(3) and loop 802(4) and distance 826 between loop 802(2) and loop 802(3), might be similarly adjusted to achieve a more evenly distributed magnetic field. An unevenly distributed field with desirable features might also be arranged.

Since each loop 802 is connected in parallel rather than series, the total inductance is far lower, allowing for a lower voltage, higher current drive waveform. Since each loop 802 will start with a similar potential, the effective capacitance between each turn is reduced. The overall resistance is also reduced. Since the overall potential required is reduced, stray E-field is reduced. Multifilament transmitter coupler 800 is shown with the path of the some loops being concentric for a majority of their respective paths, with the first path being entirely inside the second path. A plurality of additional coupler loops is also provided, wherein each coupler loop of the plurality of additional coupler loops has a path approximating a rectangle for a majority of its path and encloses each of its interior loops.

A loop's resonant capacitors can be implemented in various ways. For example, they can all be tuned to resonance. In that case, since smaller loops have smaller inductances, they would have different capacitor values for each loop. This will tend to equalize the current in each loop. Another approach is to tune the resonant capacitors to adjust the power in each loop. Depending on geometry, increasing the current in the outer loops may result in a more evenly distributed magnetic field, and this can be beneficial to wireless chargers.

It may be that the outer loops are tuned to resonance or near resonance, and the inner loops are tuned further from resonance. This may reduce current in the inner loops and result in a more evenly distributed magnetic field overall. In some cases, this may result in similar (or identical) values of capacitor for each loop, as the outer loops are progressively detuned.

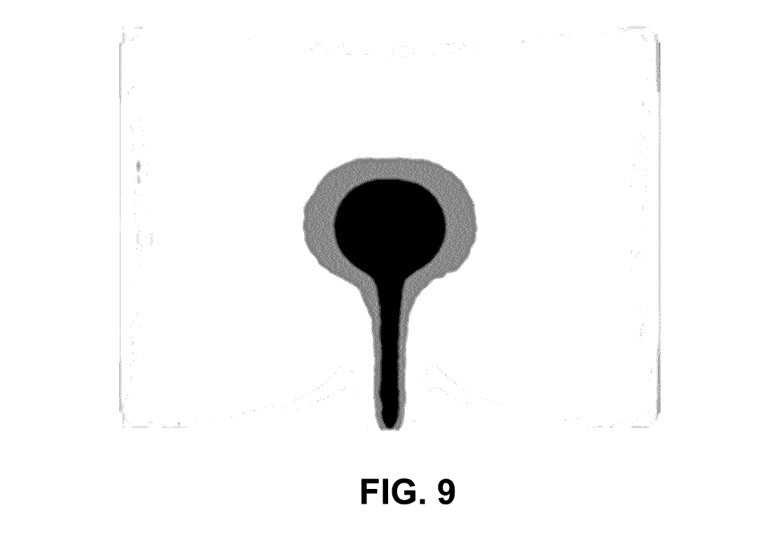

FIG. 9 is a plot of magnetic field intensity of a field that might be generated using the coil arrangement of multifilament transmitter coupler 800 of FIG. 8. With this arrangement of multiple loops, a more evenly distributed magnetic field is achieved.

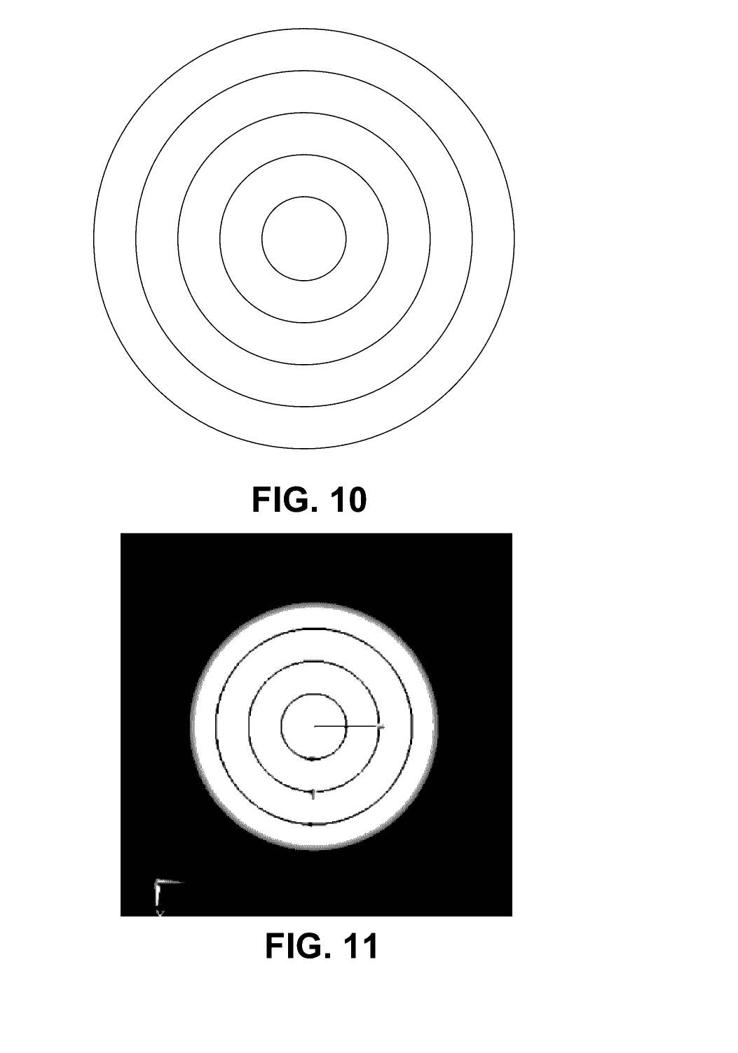

FIG. 10 is a diagram of a simulated multifilament transmitter coupler with current sharing, having five circular loops, in accordance with another exemplary implementation. In this simulated multifilament transmitter coupler, the circular loops are evenly spaced. It can be shown that if the current is controlled properly in each resonator, the resulting field is very uniform, which is a desirable characteristic in certain wireless power transmit systems.

FIG. 11 is a plot of magnetic field intensity of a field that might be generated using a coil arrangement in a simulation of the simulated multifilament transmitter coupler of FIG. 10. This coil arrangement might form the basis for a circuit that is implemented using component values indicated by the simulation to provide a more evenly distributed magnetic field intensity.

FIG. 12 is a schematic diagram of a circuit implementing the simulated multifilament transmitter coupler represented in FIGS. 10-11. For this example, inductance and AC resistance were calculated based on wire loops ranging from 100 to 500 mm in diameter and a low source resistance AC voltage source was assumed. The currents listed to the right of each loop circuit are the ideal currents that would produce the most uniform possible field with this arrangement of resonators. In the simulation, the capacitance value of the largest resonator was chosen to be at resonance to maximize current flow. Capacitance values for the other resonators were adjusted to create currents close to the target.

FIG. 13 is a table of circuit element values of the circuit components illustrated in FIG. 12 and some of the simulation results. Note that currents close to the target were achieved. Also note that capacitance values start close to resonance when high currents are required, then move away from the ideal resonance value as current requirements decrease. This can be statically (at the time of design) or dynamically (with some means of adjusting during operation to maintain a given current balance). It should be understood that the values of FIG. 13 are examples for illustration and are not intended to be the only possible values that can be used.

It should be apparent upon reading this disclosure that values for coil length, capacitance, resonant frequency, currents, etc. might be different for different applications and can be determined in a straightforward manner without undue experimentation after reading this disclosure. For example, a simulation can be performed as explained herein to identify a desired magnetic field patterned for a proposed set of multifilament coupler loops. From there, some suitable component values might be determined. Then, when a prototype or production device is built, those component values might serve as a starting point for optimizing actually produced devices to account for differences from the simulated environment. For example, in the simulation described above, the coupler loops are completely circular loops. In a practical implementation, there may be some deviation from perfect circles, for example, to allow for connections to capacitors and current input wires. As another example, an actual device might not draw exactly the currents shown in the rightmost column of the table in FIG. 13 and the capacitances used (Cₙ) for resonance might be adjusted as needed to bring the ratios of the currents within a desired tolerance. Alternatively, a device can be built and the magnetic field generated can be measured directly and used for guiding modifications for component values.

Note that the lengths of the coils for the simulated circuit are in increments of 100 millimeters. Assuming circular paths, the area inside each coil would go up as the square of the length of the coil, so the current targets for coils of length 100 mm, 200 mm, 300 mm, 400 mm, and 500 mm are 0.1 A, 0.4 A, 0.9 A, 1.6 A, and 2.5 A respectively. The values of the capacitors and inductors can be determined based on the frequency of the applied voltage and the relative impedances needed to reach those target currents in each coil.

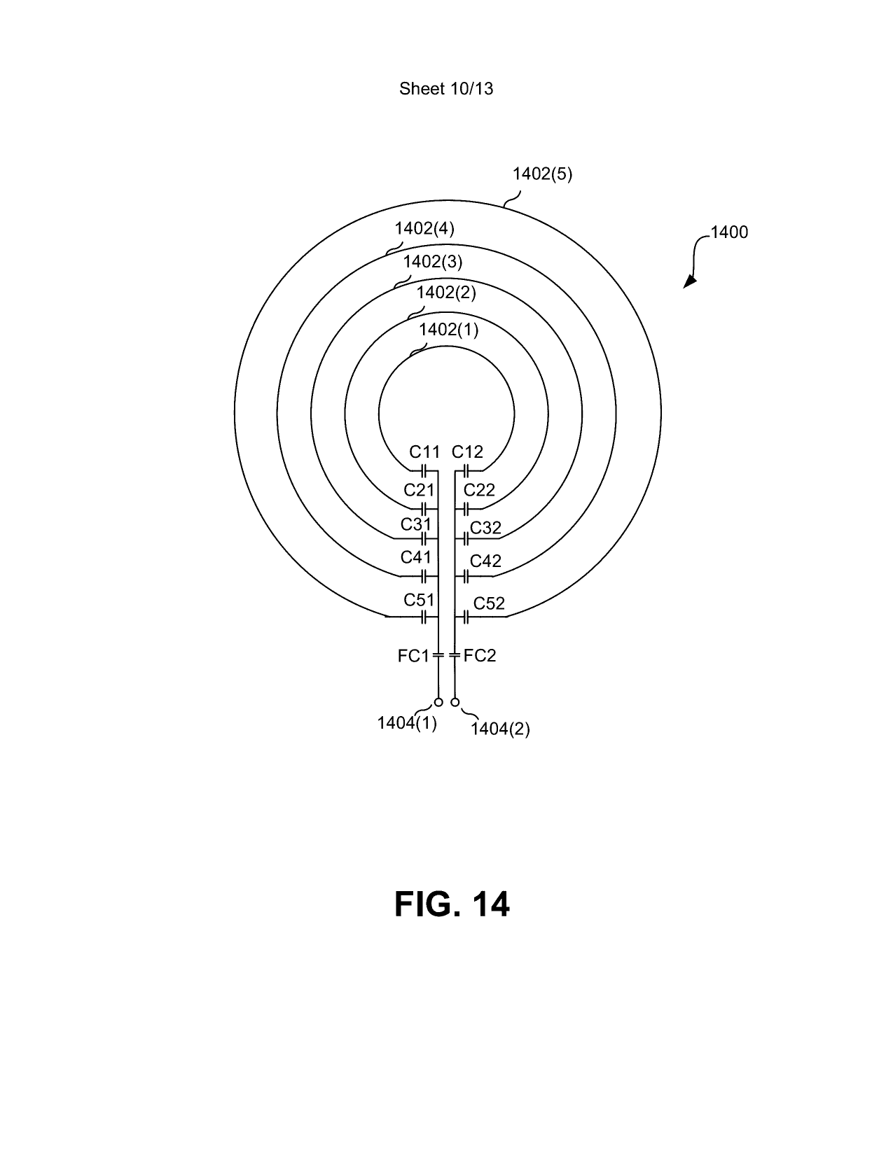

Different shapes and components are possible and circular paths are not required. FIGS. 14-17 show some variations, but it should be understood that these are not limiting embodiments. Upon reading this disclosure, it should be apparent to one of ordinary skill in the art how to select component values for different shapes of coils, different field levels needed, different loop resistances, and different input frequencies.

FIG. 14 is a diagram of a multifilament transmitter coupler 1400 with current sharing, in accordance with a further exemplary implementation. In some cases it may be advantageous to adaptively tune the various loops by using variable capacitors in combination with the fixed resonant capacitors. This allows retuning the loops when the loops are detuned by metallic devices placed on or near them. In some cases, this can be done with some of the required capacitance in the individual loops and some in a feed capacitance as in FIG. 14.

As illustrated there, multifilament transmitter coupler 1400 has four loops 1402(1) to 1402(4) and corresponding loop capacitances C11, C12, C21, C22, C31, C32, C41, C42, C51 and C52, as shown. The current induced by the driving signal across connections 1404(1) and 1404(2) would divide over those five loops based on their impedance at the driving signal frequency. Additional capacitance is provided by feed capacitor FC1 in series after connection 1404(1) and feed capacitor FC2 in series after connection 1404(2). Some of these capacitances can be variable to allow for tuning, if needed. The loop capacitances, in some embodiments, are similar in ratio to the values given in FIG. 13.

In a specific implementation, feed capacitors, FC1 and FC2 might be 2200 pf or other similar values, and the loop capacitances have the values shown in FIG. 13. For example, C11 and C12 would each be 4390 pf (so that C11 and C12, being in series, together provide a loop capacitance of 2195 pf). C21 and C22 would each be 1870 pf; C31 and C32 would each be 1148 pf; C41 and C42 would each be 816 pf; and C51 and C52 would each be 626 pf. This is one example, and other examples should be apparent upon reading this disclosure.

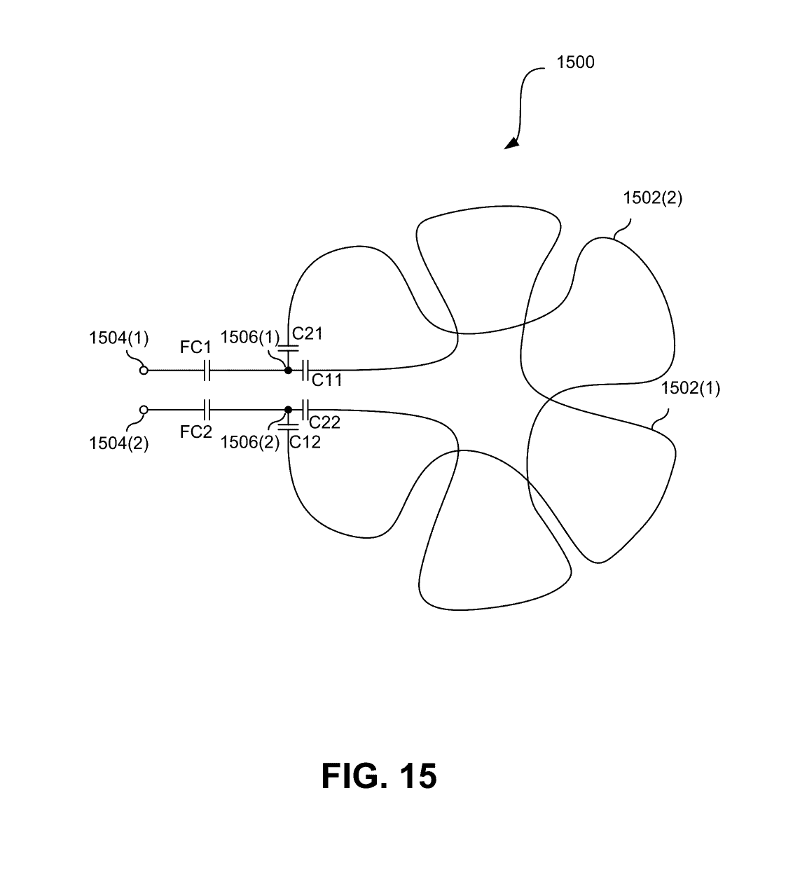

For some embodiments, the resistance of each loop is a function of the length of the path of the loop and where identical resistances, or near identical resistances are desired, the lengths of the paths in those embodiments are made close to identical. In the above examples, the loops did not overlap in the plane of the loop's paths and vary in length. This is not necessarily a requirement, as the paths can be in certain layouts with identical, or nearly identical, lengths without overlapping in the plane of the loop's paths. A simple approach to nearly identical lengths uses overlapping loop paths, as FIG. 15 shows by example.

FIG. 15 is a diagram of a multifilament transmitter coupler 1500 with current sharing, having two loops 1502(1) and 1502(2) with matched lengths. With this configuration, the current in all loops can be matched in a way that provides the field-leveling effects of concentric rings but utilizes fixed length loops. This allows identical tuning and provides identical resistances between the various loops. In this example, current flowing from connection 1504(1) to 1504(2) flows through feed capacitor FC1, then splits at a junction point 1506(1) into the two loops 1502(1) and 1502(2). The current through loop 1502(1) passes through C11 and C12, while the current through loop 1502(2) passes through C21 and C22. The current in the two loops rejoins at a junction point 1506(2) and passes through feed capacitor FC2. In a specific embodiment, the capacitances C11, C12, C21, and C22 are all the same value, in another specific embodiment, capacitances C11 and C21 are the same, while C12 and C22 are the same but different from C11 and C21, and in yet another embodiment, each capacitance might be different than the others, but the sum of the reciprocals of capacitances C11 and C12 is the same as the sum of the reciprocals of capacitances C21 and C22 so that the loop capacitances are the same. With the capacitances being the same and the length being the same (so that the loop resistances are the same), current would be expected to divide equally at the junction points 1506(1) and 1506(2).

In the example illustrated in FIG. 15, loops 1502(1) and 1502(2) alternate in a petal arrangement with each loop having two and a half petals, giving a suitable coverage of an approximately circular planar area. Other variations, such as having more petals or a less circular planar area are also contemplated.

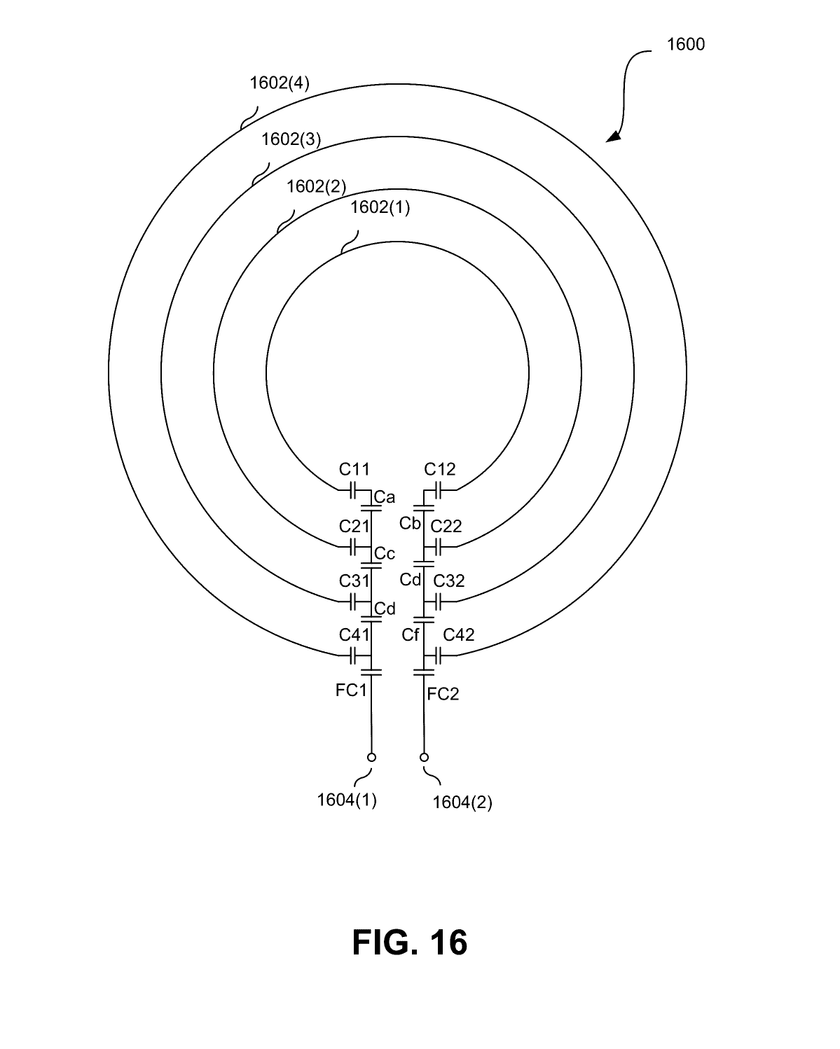

FIG. 16 is a diagram of a multifilament transmitter coupler 1600 with current sharing, having loop-to-loop coupling capacitors. In some cases, using capacitors between each loop rather than connecting them to a common parallel bus may help control multiple resonant frequency interactions. As illustrated in FIG. 16, each loop has a first capacitor between a first interior node and the loop and a second capacitor between the loop and a second interior node. There are also loop-to-loop coupling capacitors between the interior nodes. While the example of FIG. 16 shows two capacitances per loop and a loop-to-loop coupling capacitance between each of the interior nodes, there might be fewer capacitances in use.

In FIG. 16, while four loops 1602(1), 1602(2), 1602(3), and 1602(4) are illustrated, two, three, or more than four loops can be used instead. Current is supplied via connections 1604(1) and 1604(2) and passes through the four loops in proportion to their relative impedances. Current in loop 1602(1) passes through capacitances C11 and C12; current in loop 1602(2) passes through capacitances C21 and C22; current in loop 1602(3) passes through capacitances C31 and C32; and current in loop 1602(4) passes through capacitances C41 and C42.

A loop-to-loop coupling capacitor, Ca, is between an interior node of loop 1602(1) and an interior node of loop 1602(2), while a loop-to-loop coupling capacitor, Cb, is between the other two interior nodes of loops 1602(1) and 1602(2). Similarly, a loop-to-loop coupling capacitor, Cc, is between an interior node of loop 1602(2) and an interior node of loop 1602(3), a loop-to-loop coupling capacitor, Cd, is between the other two interior nodes of loops 1602(2) and 1602(3), a loop-to-loop coupling capacitor, Ce, is between an interior node of loop 1602(3) and an interior node of loop 1602(4), and a loop-to-loop coupling capacitor, Cf, is between the other two interior nodes of loops 1602(3) and 1602(4).

In some variations, separate capacitances Ca and Cb are not needed, as the proper selection of C11 and C12 could replace effects of capacitances Ca and Cb. The values for those capacitances might be determined using values from the table of FIG. 13 or might be determined using other techniques and/or values described elsewhere in this disclosure.

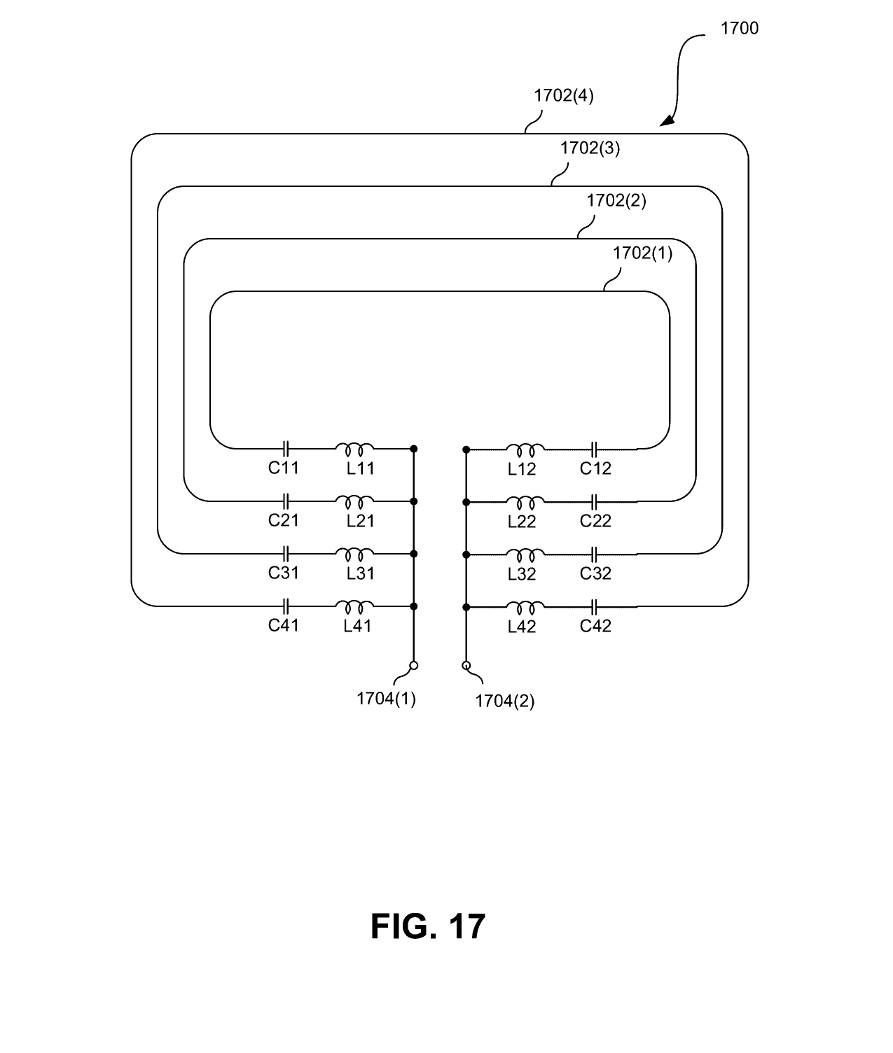

FIG. 17 is a diagram of a multifilament transmitter coupler 1700 with current sharing, having multiple loops 1702(1), 1702(2), 1702(3), and 1702(4) each having capacitors and inductors. In some cases, placing a receiving device within the coupling field in a way that covers interior coils but not exterior coils could detune the internal coils, resulting in a change in the current distribution. If needed, inductor/transformers can be added to each loop, as illustrated in FIG. 17.

As illustrated there, current applied to connections 1702(1) and 1702(2) would flow through loops 1702(1), 1702(2), 1702(3), and 1702(4). Current in loop 1702(1) flows through inductor L11, capacitor C11, capacitor C12, and inductor L12. Current in loop 1702(2) flows through inductor L21, capacitor C21, capacitor C22, and inductor L22. Current in loop 1702(3) flows through inductor L31, capacitor C31, capacitor C32, and inductor L32. Current in loop 1702(4) flows through inductor L41, capacitor C41, capacitor C42, and inductor L42. The values of these components might be as indicated in the table of FIG. 13 or preferred values easily determined experimentally after reading this disclosure. For example, the capacitances used might be four adjacent capacitance values from the table of FIG. 13 apportioned between the two loop capacitances and the inductances being selected for resonance at a resonant frequency or selected to match those shown in the table of FIG. 13.

The inductor/transformers may have a number of turns proportional to the current in each loop. Such transformers will have various effects. One effect is that their leakage inductance may serve as an unchanging, non-detunable inductance. Thus, any detuning effect caused by a change in inductance in the loop itself will be reduced, since the total inductance in the coil (transformer leakage+loop itself) will change a smaller percentage. Another effect is that the transformer windings will couple to each other and tend to oppose a change in current ratios. If the currents match the transformer ratios, the transformer will have minimal or no effect and simply pass the current to the resonator.

Using one or more of the elements, techniques and/or components described above, a suitable multifilament transmitter coupler can be designed. Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

The terminology used herein is for the purpose of describing particular implementations only and is not intended to be limiting of the disclosure. It will be understood by those within the art that if a specific number of a claim element is intended, such intent will be explicitly recited in the claim, and in the absence of such recitation, no such intent is present. For example, as used herein, the singular forms “a”, “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The use of any and all examples is intended merely to better illuminate embodiments of the invention and does not pose a limitation on the scope of the invention unless otherwise claimed. No language in the specification should be construed as indicating any non-claimed element as essential to the practice of the invention.

What is claimed is:

1. A wireless power transmitter for generating a magnetic field, the wireless power transmitter comprising:
a first coupler loop, coupled between a first electrical connection and a second electrical connection, the first electrical connection and the second electrical connection capable of receiving a driving signal and configured to allow the driving signal applied across the first electrical connection and the second electrical connection to cause a first current to flow in the first coupler loop and generate a first magnetic field component; and
a second coupler loop, coupled between the first electrical connection and the second electrical connection, the first electrical connection and the second electrical connection further configured to allow the driving signal applied across the first electrical connection and the second electrical connection to cause a second current to flow in the second coupler loop and generate a second magnetic field component, wherein the first current is different from the second current.

2. The wireless power transmitter of claim 1, wherein an apportionment of current from the driving signal to the first current and to the second current is determined by a proportion of an impedance of the first coupler loop and an impedance of the second coupler loop, and wherein the impedance of the first coupler loop and the impedance of the second coupler loop divide the current from the driving signal to create a distributed magnetic field that is more evenly distributed over the first and second coupler loops than if the first current and the second current are constrained to be equal.

3. The wireless power transmitter of claim 1, further comprising additional coupler loops, wherein an apportionment of current from the driving signal to currents for each of the first coupler loop, the second coupler loop, and the additional coupler loops is determined by relative impedances of the first coupler loop, the second coupler loop, and the additional coupler loops and wherein the relative impedances divide the current from the driving signal to create a distributed magnetic field that is more evenly distributed over the first coupler loop, the second coupler loop, and the additional coupler loops than if the currents for each of the first coupler loop, the second coupler loop, and the additional coupler loops are constrained to be equal.

4. The wireless power transmitter of claim 1, further comprising:
a first capacitor between a first end of the first coupler loop and the first electrical connection; and
a second capacitor between a first end of the second coupler loop and the first electrical connection,
wherein relative values of the first capacitor and the second capacitor correspond to capacitances that tune the first coupler loop and the second coupler loop to cause the first current and the second current, at or around a driving signal frequency, to create a more evenly distributed magnetic field between the first magnetic field component and the second magnetic field component than would be generated if the first current and the second current were equal.

5. The wireless power transmitter of claim 4, further comprising:
a third capacitor between a second end of the first coupler loop and the second electrical connection; and
a fourth capacitor between a second end of the second coupler loop and the second electrical connection, wherein relative values of the first capacitor, the second capacitor, the third capacitor, and the fourth capacitor correspond to capacitances that tune the first coupler loop and the second coupler loop to cause the first current and the second current, at or around the driving signal frequency, to provide the more evenly distributed magnetic field.

6. The wireless power transmitter of claim 5, further comprising:
a first feed capacitor, electrically connected at a first end to the first electrical connection and electrically connected at a second end to both the first capacitor and the second capacitor; and
a second feed capacitor, electrically connected at a first end to the second electrical connection and electrically connected at a second end to both the third capacitor and the fourth capacitor.

7. The wireless power transmitter of claim 4, wherein a first impedance of the first capacitor and the first coupler loop is less than a second impedance of the second capacitor and the second coupler loop at the driving signal frequency.

8. The wireless power transmitter of claim 1, wherein the first coupler loop is positioned about a first path and the second coupler loop is positioned about a second path, wherein the first path and the second path are concentric for a majority of their respective paths, with the first path being entirely inside the second path.

9. The wireless power transmitter of claim 8, further comprising a plurality of additional coupler loops, wherein each coupler loop of the plurality of additional coupler loops has a path approximating a rectangle for a majority of its path and encloses the first path and the second path.

10. The wireless power transmitter of claim 8, further comprising:
a third coupler loop, coupled between the first electrical connection and the second electrical connection and having a third path; and
a fourth coupler loop, coupled between the first electrical connection and the second electrical connection and having a fourth path, wherein the first path, the second path, the third path, and the fourth path are concentric for a majority of their respective paths, with the first path being entirely inside the second path, the second path being entirely inside the third path, and the third path being entirely inside the fourth path.

11. The wireless power transmitter of claim 1, wherein the first coupler loop is positioned about a first path and the second coupler loop is positioned about a second path, wherein the first path is inside the second path for first portions of the first path and outside the second path for second portions of the first path.

12. The wireless power transmitter of claim 1, further comprising:
a first capacitor between the first electrical connection and a first interior node of the wireless power transmitter;
a second capacitor between the first interior node and a first end of the second coupler loop;
a third capacitor between the first interior node and a second interior node of the wireless power transmitter;
a fourth capacitor between the second interior node and a first end of the first coupler loop;
a fifth capacitor between the second electrical connection and a third interior node of the wireless power transmitter;
a sixth capacitor between the third interior node and a second end of the second coupler loop;
a seventh capacitor between the third interior node and a fourth interior node of the wireless power transmitter; and
an eighth capacitor between the fourth interior node and a second end of the first coupler loop.

13. The wireless power transmitter of claim 1, further comprising:
a first inductor and a first capacitor coupled in series between the first electrical connection and a first end of the first coupler loop;
a second inductor and a second capacitor coupled in series between the first electrical connection and a first end of the second coupler loop;
a third inductor and a third capacitor coupled in series between the second electrical connection and a second end of the first coupler loop; and
a fourth inductor and a fourth capacitor coupled in series between the second electrical connection and a second end of the second coupler loop.

14. A wireless power transmitter, comprising:
circuitry configured to generate a driving signal;
a pair of electrical connections comprising a first electrical connection and a second electrical connection;
a transmitter pad coupled to the pair of electrical connections to receive the driving signal;
a first coupler loop along a first path enclosed within the transmitter pad, coupled between the first electrical connection and the second electrical connection;
a second coupler loop along a second path enclosed within the transmitter pad, coupled between the first electrical connection and the second electrical connection, the second coupler loop being electrically in parallel with the first coupler loop and separated from the first coupler loop along a loop longitude sufficient to generate distinguishable magnetic field components among the first coupler loop and the second coupler loop; and
tuning elements that tune a resonance of the first coupler loop and the second coupler loop independently of each other.

15. The wireless power transmitter of claim 14, further comprising:
a first capacitor between a first end of the first coupler loop and the first electrical connection; and
a second capacitor between a first end of the second coupler loop and the first electrical connection, wherein relative values of the first capacitor and the second capacitor correspond to capacitances that tune, at or around a driving signal frequency, the first coupler loop to carry a first current to generate a first magnetic field component and the second coupler loop to carry a second current to generate a second magnetic field component, wherein the first current and the second current are different and create a more evenly distributed magnetic field between the first magnetic field component and the second magnetic field component than would be generated if the first current and the second current were equal.

16. The wireless power transmitter of claim 15, further comprising:
a third capacitor between a second end of the first coupler loop and the second electrical connection; and
a fourth capacitor between a second end of the second coupler loop and the second electrical connection, wherein relative values of the first capacitor, the second capacitor, the third capacitor, and the fourth capacitor correspond to capacitances that tune, at or around a driving signal frequency, the first coupler loop to carry the first current and the second coupler loop.

17. The wireless power transmitter of claim 16, further comprising:
a first feed capacitor, electrically connected at a first end to the first electrical connection and electrically connected at a second end to both the first capacitor and the second capacitor; and
a second feed capacitor, electrically connected at a first end to the second electrical connection and electrically connected at a second end to both the third capacitor and the fourth capacitor.

18. The wireless power transmitter of claim 14, wherein the first path and the second path are along concentric circles for a majority of their respective paths, with the first path being entirely inside the second path.

19. The wireless power transmitter of claim 18, wherein the first path and the second path approximate rectangles for a majority of their paths, with the second path enclosing the first path.

20. The wireless power transmitter of claim 14, further comprising:
a third coupler loop positioned along a third path coupled between the first electrical connection and the second electrical connection; and
a fourth coupler loop positioned along a fourth path coupled between the first electrical connection and the second electrical connection, wherein the first path, the second path, the third path, and the fourth path are concentric for a majority of their respective paths, with the first path being entirely inside the second path, the second path being entirely inside the third path, and the third path being entirely inside the fourth path.

21. The wireless power transmitter of claim 14, wherein the first path is inside the second path for first portions of the first path and wherein the first path is outside the second path for second portions of the first path.

22. The wireless power transmitter of claim 14, further comprising:
a first capacitor between the first electrical connection and a first interior node;
a second capacitor between the first interior node and a first end of the second coupler loop;
a third capacitor between the first interior node and a second interior node;
a fourth capacitor between the second interior node and a first end of the first coupler loop;
a fifth capacitor between the second electrical connection and a third interior node;
a sixth capacitor between the third interior node and a second end of the second coupler loop;
a seventh capacitor between the third interior node and a fourth interior node; and
an eighth capacitor between the fourth interior node and a second end of the first coupler loop.

23. The wireless power transmitter of claim 14, further comprising:
a first inductor and a first capacitor in series between the first electrical connection and a first end of the first coupler loop;
a second inductor and a second capacitor in series between the first electrical connection and a first end of the second coupler loop;
a third inductor and a third capacitor in series between the second electrical connection and a second end of the first coupler loop; and
a fourth inductor and a fourth capacitor in series between the second electrical connection and a second end of the second coupler loop.

24. A method of providing power wirelessly to devices having wireless power receivers and positioned to wirelessly receive power via a magnetic field, the method comprising:
receiving a driving signal across a pair of electrical connections comprising a first electrical connection and a second electrical connection;
apportioning current of the driving signal to a first coupler loop and a second coupler loop, the first coupler loop being along a first path connecting the first electrical connection and the second electrical connection and the second coupler loop being along a second path connecting the first electrical connection and the second electrical connection;
generating a first magnetic field component when a first current flows in the first coupler loop; and
generating a second magnetic field component when a second current flows in the second coupler loop, wherein the second path is sufficiently distinct from the first path that the first magnetic field component and the second magnetic field component are distinguishable to a wireless power receiver, wherein the first current is different than the second current.

25. The method of claim 24, wherein apportioning the current of the driving signal comprises apportioning the current using a first loop impedance of the first coupler loop and a second loop impedance of the second coupler loop, wherein the first loop impedance and the second loop impedance divide the current from the driving signal to create a distributed magnetic field that is more evenly distributed over an area for wirelessly receiving power via a magnetic field than if the first current and the second current were constrained to be equal.

26. The method of claim 25, wherein apportioning the current of the driving signal comprises apportioning the current over additional coupler loops to form a wireless power transmitter that uses more than two coupler loops.

27. The method of claim 24, wherein providing power wirelessly further comprises providing power to a set of wireless receivers having a predefined range of sizes of receiver couplers through a transmitter pad having a width dimension and a length dimension, wherein the width dimension and the length dimension define an approximately rectangular surface sufficiently large to simultaneously accommodate multiple wireless receivers of the set of wireless receivers, each of which might be placed anywhere on the approximately rectangular surface.

28. A wireless power transmitter, comprising:
means for generating a driving signal;
means for conveying a driving signal current;
first means for emitting a first magnetic field;
second means for emitting a second magnetic field;
means for supporting the first means for emitting along a first path and the second means for emitting along a second path separated from the first path sufficient to generate distinguishable magnetic field components as between the first means for emitting and the second means for emitting;
means for partitioning the driving signal current between the first means for emitting and the second means for emitting; and
means for tuning a resonance of the first means for emitting and the second means for emitting independently of each other.

29. The wireless power transmitter of claim 28, further comprising:
means for creating a first impedance of the first means for emitting; and
means for creating a second impedance of the second means for emitting.

30. The wireless power transmitter of claim 28, wherein the means for supporting is configured to allow for placement of a set of wireless receivers having a predefined range of sizes of receiver couplers, and defining an approximately rectangular surface sufficiently large to simultaneously accommodate multiple wireless receivers of the set of wireless receivers, each of which might be placed anywhere on the rectangular surface.
